(19) United States
(12) Patent Application Publication
(10) Pub. No.: US 2007/0159817 A1
(43) Pub. Date: Jul. 12, 2007

(54) Yard sign illuminating device and system

(76) Inventors: Donald F. Evans, Pinehurst, NC (US); Mark D. Schmidt, Durham, NC (US); Larson Isely, Raleigh, NC (US); Jeffrey Hatley, Mebane, NC (US); Michael Roth, Austin, TX (US)

Correspondence Address: ALSTON & BIRD LLP, BANK OF AMERICA PLAZA, 101 SOUTH TRYON STREET, SUITE 4000, CHARLOTTE, NC, 28280-4000, US

(21) Appl. No.: 11/443,755

(22) Filed: May 31, 2006

Related U.S. Application Data
(60) Provisional application No. 60/757,654, filed on Jan. 10, 2006.

(51) Int. Cl. F21L 4/00; F21V 23/04; G09F 13/00

(52) U.S. Cl. 362/191; 362/276; 40/541

(57) ABSTRACT

The present invention is directed to a device for illuminating a yard sign that uses an efficient beam of light and is adapted to cycle on and off. The illuminating device includes a main body portion, a switch, a control circuit, a power source, at least one arm adjustably attached to the main body portion, and a light head disposed proximate an end of the at least one arm, the light head comprising at least one light emitting diode (LED) assembly. The control circuit is configured to automatically cycle the LED assembly on and off when activated by the switch.

### CROSS-REFERENCE TO RELATED APPLICATIONS

This application claims the benefit of U.S. Provisional Application No. 60/757,654, filed Jan. 10, 2006, which is entitled “Automatic Yard Sign Illuminating Device” and is incorporated by reference herein in its entirety.

### BACKGROUND OF THE INVENTION

1. Field of the Invention

The present invention relates to illumination devices generally, and more particularly, to a device that is capable of illuminating a yard sign and that is adapted to automatically turn on and off at selected time intervals.

2. Description of the Related Art

Real estate brokers, property owners selling their own property, campaigning public officials, and others commonly make use of yard signs. Typically these signs include information associated with the sale of the property (e.g., realtor name, phone number, asking price, etc.) or information associated with a public announcement or election (e.g., candidate name, bond initiative slogan, etc.). Often these signs are placed in residential yards or other high traffic areas such as those disposed along roads or sidewalks. Yard signs of the type described above are low-cost, generally effective devices for conveying information to the public. However, yard signs do possess a few drawbacks. For example, yard signs are relatively small in size and are generally not visible at night.

It would therefore be desirable to provide a device and system for illuminating a yard sign. The device should be efficient, compact such that its does not significantly obscure the information on the sign, weather resistant, and low cost. The device should also be capable of turning on and off automatically at selected time intervals.

### BRIEF SUMMARY OF THE INVENTION

The present invention addresses the above needs and achieves other advantages by providing a device for illuminating a yard sign that is structured to be removably inserted into the ground. The illuminating device of the present invention uses an efficient beam of light and, in various embodiments, is adapted to cycle on and off. In one embodiment, the present invention provides an illuminating device that comprises a main body portion configured to attach to the yard sign, a control circuit, a power source, at least one arm attached to the main body portion, and a light head disposed proximate an end of the at least one arm, the light head comprising at least one light emitting diode (LED) assembly.

Conventional yard signs typically comprise a sign portion and a frame portion that is adapted to support the sign portion. In one embodiment, the main body portion of the illuminating device may be structured to attach to the frame of the yard sign. In another embodiment, the main body portion may be structured to attach to the sign portion of the yard sign. In yet another embodiment, the at least one arm and the light head may be structured such that they do not significantly obscure sign information disposed on the yard sign. In yet another embodiment, the main body portion may attach to the yard sign using snap members, magnets, hook and loop straps, cable ties, fasteners, screws, or other attaching elements.

In other embodiments, the LED assembly may comprise at least one of a high brightness white LED, a blue LED, a red LED, an orange LED, an amber LED, a yellow LED, a green LED, a bi-color LED, a tri-color LED, or any combination thereof. In still other embodiments, the power source may comprise a direct current power source and/or an alternating current power source. Direct current power sources may include, but are not limited to, a battery power source and a solar cell power source. In other embodiments, the illuminating device may further comprise a switch that is adapted to signal the control circuit for activation and deactivation of the LED assembly.

In another embodiment, the present invention provides an illuminating device that comprises a main body portion configured to attach to the sign portion, a control circuit, a power source, at least one arm attached to the main body portion, a photosensor adapted to sense an ambient light level, and a light head disposed proximate an end of the at least one arm. The light head may be adapted to comprise at least one light emitting diode (LED) assembly. Additionally, the control circuit may be structured to automatically cycle the LED assembly on and off in response to a sensed level of ambient light from the photosensor.

In another embodiment, the present invention provides an illuminating device that comprises a main body portion configured to attach to the yard sign, a switch, a control circuit, a power source, at least one arm attached to the main body portion, and a light head disposed proximate an end of the at least one arm, the light head comprising at least one light emitting diode (LED) assembly. The control circuit may be configured to automatically cycle the LED assembly on and off when activated by the switch. In another embodiment, the illuminating device may further include a removable cap attached to a first end of the main body portion, and a rotatable user interface portion located at a second end of the main body portion. In one embodiment, the rotatable user interface portion may be generally integral to the main body portion and the rotatable user interface portion may engage the switch thereby activating the control circuit to automatically cycle the LED assembly on and off.

In another embodiment, the at least one arm may include a first end that is generally fixed adjacent the main body portion and a second end that is adapted to support a light head and is generally movable away from the main body portion. In yet another embodiment, two positionable arms may be affixed to the main body portion and configured to illuminate opposing sides of the sign portion of the yard sign. In yet another embodiment, the at least one arm may be disposed in at least an operating position and a retracted position. In the retracted position, the at least one arm may be aligned along the length of the main body portion. In another embodiment, the at least one arm may also be configured to lock into position when in the operating position. In yet another embodiment, the main body portion may possess a generally cylindrical shape and the at least one battery and the control circuit may be at least partially enclosed within the main body portion.

### BRIEF DESCRIPTION OF THE SEVERAL VIEWS OF THE DRAWING(S)

Having thus described the invention in general terms, reference will now be made to the accompanying drawings, which are not necessarily drawn to scale, and wherein:

FIG. 1 is a perspective view of an illuminating device attached to a yard sign in accordance with one embodiment of the present invention;

FIG. 1A is a perspective view of an illuminating device attached to a yard sign in accordance with another embodiment of the present invention;

FIG. 1B is a perspective view of an illuminating device attached to a yard sign in accordance with another embodiment of the present invention;

FIG. 2 is a perspective view of an illuminating device structured in accordance with one embodiment of the present invention;

FIG. 3 is a front view of an illuminating device structured in accordance with one embodiment of the present invention;

FIG. 4 is a side view of an illuminating device structured in accordance with one embodiment of the present invention;

FIG. 5 is a partially exploded view of an illuminating device structured in accordance with one embodiment of the present invention;

FIG. 6 is a schematic illustration of selected electronic components used in an illuminating device structured in accordance with one embodiment of the present invention; and

FIG. 7 is an isometric view of an illuminating device configured in a folded position in accordance with one embodiment of the present invention.

### DETAILED DESCRIPTION OF THE INVENTION

The present invention now will be described more fully hereinafter with reference to the accompanying drawings, in which some, but not all embodiments of the invention are shown. Indeed, this invention may be embodied in many different forms and should not be construed as limited to the embodiments set forth herein; rather, these embodiments are provided so that this disclosure will satisfy applicable legal requirements. Like numbers refer to like elements throughout.

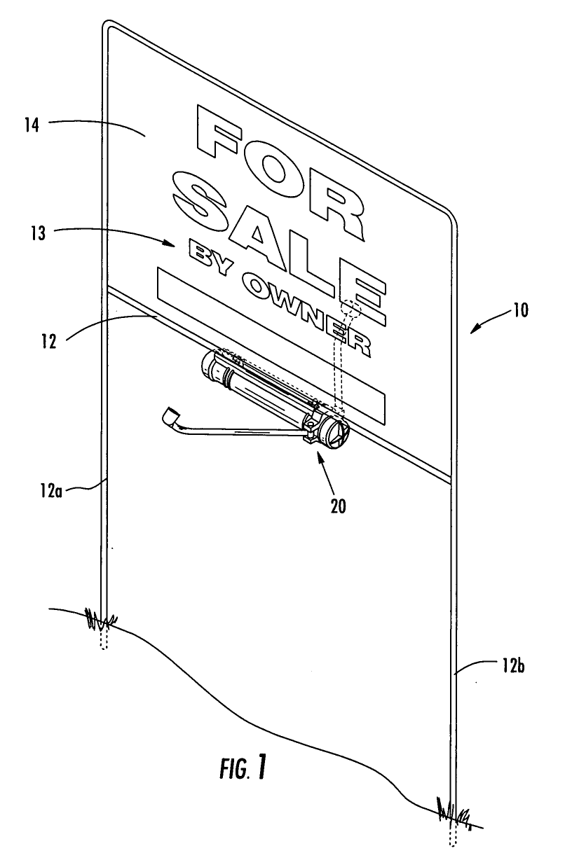

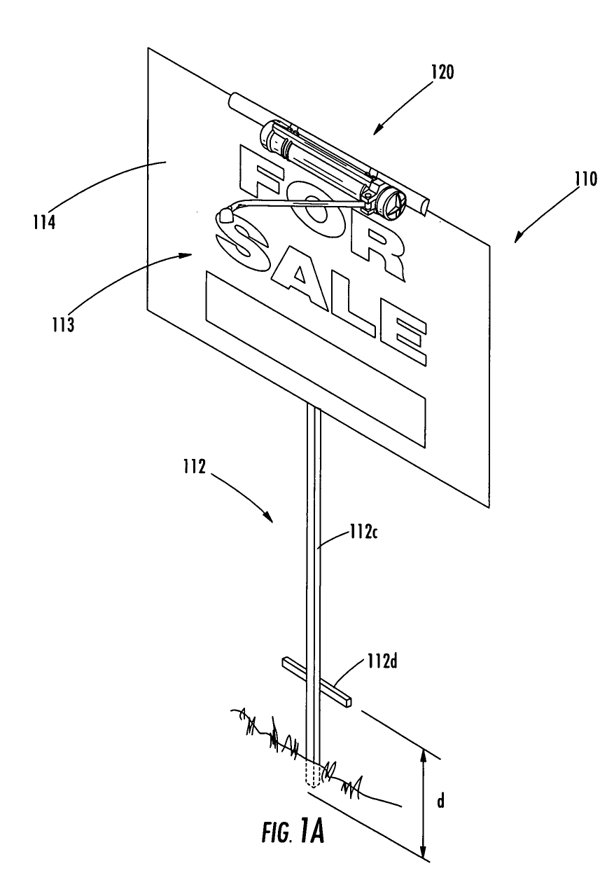

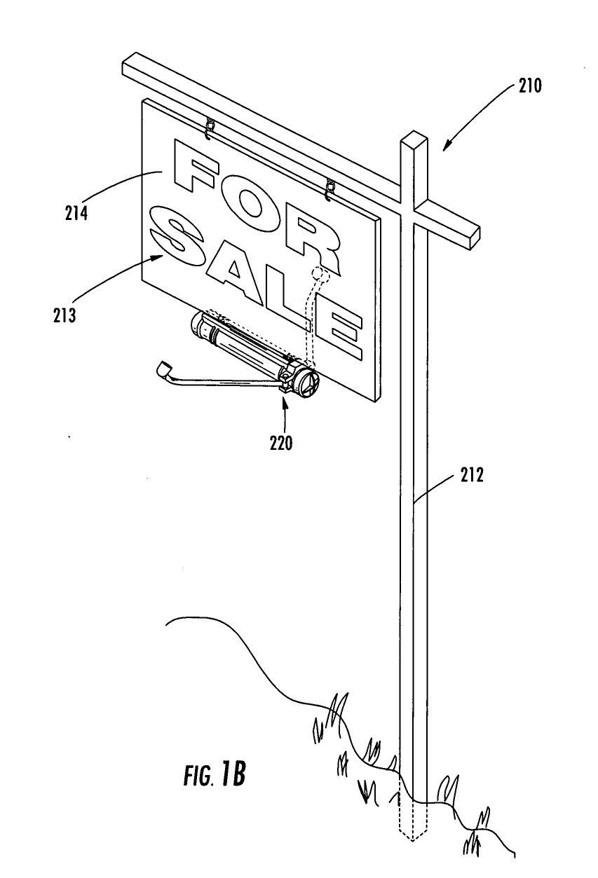

FIG. 1 shows an isometric view of an illuminating device 20 attached to a yard sign 10 in accordance with one embodiment of the present invention. The depicted yard sign 10 includes a frame 12 and a sign portion 14 that is supported by the frame 12. Yard signs of the type depicted in FIG. 1 are generally designed to be light-weight, low-cost, devices for conveying information to a viewer. Such signs generally include a portion of the frame that is inserted into the ground in order to support the yard sign in an upright position. In the depicted embodiment, the frame includes legs 12a, 12b that are configured to penetrate the ground when a downward force is exerted on the frame 12. One or more horizontally extending foot-pushes (not shown) may be disposed along the length of the frame legs 12a, 12b to assist a user in driving the legs 12a, 12b into the ground as will be discussed in greater detail below.

FIG. 1A shows a perspective view of an illuminating device 120 attached to a yard sign 110 in accordance with another embodiment of the present invention. Notably, illuminating devices structured according to various embodiments of the present invention may be attached to a yard sign in a variety of positions. For example, in FIG. 1 the illuminating device 20 is attached to the frame 12 generally adjacent a lower edge of the sign portion 14 of the yard sign 10 as shown. However, in FIG. 1A, the illuminating device 120 is attached to the frame 112 generally adjacent an upper edge of the sign portion 114 of the yard sign 110 as shown. A top, bottom, lateral edge, or other similar illuminating device attachment position may be specifically desired by a user based upon the orientation of the information disposed on the sign portion of the yard sign as will be apparent to one of ordinary skill in the art in view of this disclosure. In this regard, various embodiments of the present invention may be adapted to accommodate each of the above attachment positions.

As noted above, simple yard signs of the type depicted may be structured to include horizontally extending foot-pushes that are disposed along the legs of a yard sign to assist a user in driving the legs into the ground. FIG. 1A depicts a yard sign 110 supported by a frame 112 having a single leg 112c. The depicted yard sign 110 also includes a foot-push 112d. In various applications, the foot-push 112d may be set at a desired penetration depth d above the tip of the leg 112c as shown. Thus, a user may simply step on the foot-push 112d to properly seat the leg 112c into the ground the desired penetration depth d.

Various light-weight illumination device embodiments of the present invention are particularly suited for attachment to the simple “staked” yard signs 110 depicted in FIGS. 1 and 1A. For example, illumination devices structured in accordance with various embodiments of the present invention may possess a pre-battery weight approximately between 200 and 400 grams, preferably 300 grams. Other illumination device embodiments may possess an operational weight (including batteries) approximately between 800 and 1000 grams, preferably 900 grams. As will be apparent to one of ordinary skill in the art, based on the constituent materials selected, illumination devices may be structured as set forth herein without falling directly within the weight ranges set forth above and, thus, the inventive concepts herein described are not limited to such weight ranges.

Illuminating devices structured according to various embodiments of the present invention may also be adapted for attachment to relatively stronger, more-durable, yard signs of the type depicted in FIG. 1B. Notably, the compact, light-weight, and durable design of the various illumination device embodiments, as discussed in greater detail below, desirably allows for attachment of such devices to the pivotally attached sign portion 214 of the yard sign 210 rather than exclusively requiring attachment to the relatively more stable frame portion 212 of the sign as shown. Of course, where desired, frame attachment is certainly embodied by the inventive concepts herein described.

As noted above, yard signs of the types depicted in FIGS. 1, 1A, and 1B are generally placed in residential yards or other high traffic areas along roads or sidewalks to maximize the number of people who may encounter the sign. The present invention furthers this effort by providing efficient illumination of such yard signs such that they may be effective for conveying information during low ambient light and nighttime conditions. Additionally, as demonstrated in the drawings, illuminating devices structured in accordance with various embodiments of the present invention have a compact size that does not significantly obscure sign information located on the sign portion, and, as will be discussed below, provides an efficient source of light by using a light emitting diode (LED) assembly.

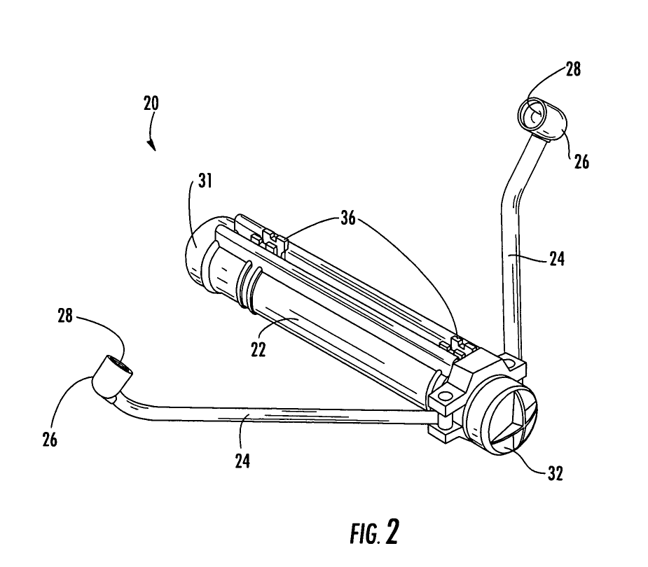

FIGS. 2-4 depict an illuminating device 20 structured in accordance with one embodiment of the present invention. Illumination devices that are structured in accordance with various embodiments of the present invention generally comprise a main body portion 22 that is structured to attach to a yard sign, and at least one arm 24 structured to support a light source. The depicted illuminating device 20 includes a pair of arms 24 attached to the main body portion 22. The depicted illuminating device 20 also includes a main body portion 22 that is structured as a cylindrical tube-like structure constructed, in one embodiment, of a polymer such as acrylonitrile-butadiene-styrene (ABS). The depicted main body portion 22 is sized to receive a series of batteries as will be discussed below.

Although depicted generally as a cylinder, the main body portion 22 may be structured in any shape and may be constructed out of any material that is sufficient to support the at least one arm 24 and that is capable of protecting the internal components (e.g., batteries, circuit boards and associated electrical connections) of the illuminating device 20 from rain, dust, dirt, and other environmental elements. Illumination devices structured in accordance with various embodiments of the present invention may also be constructed from materials selected based upon their ability to withstand outdoor temperatures ranging generally between approximately −18 degrees Celsius (0 degrees Fahrenheit) and approximately 55 degrees Celsius (131 degrees Fahrenheit). Finally, materials used to produce illumination devices structured according to various embodiments of the present invention may be selected to ensure that the device has a light-weight and durable construction.

Illumination devices structured in accordance with various embodiments of the present invention also include an attachment portion 36 extending from the main body portion 22 for coupling the illumination device to a yard sign 10. In the depicted embodiment, the attachment portion 36 comprises opposed first and second snap members that are adapted to snap onto opposite sides of the frame 12 or other portion of the yard sign 10 as shown in FIGS. 1, 1A, and 1B. In alternate embodiments, however, the attachment portion 36 may be comprised of other attachment elements that are capable of securing the main body portion 22 to the yard sign 10, including, but not limited to, magnets, hook and loop fabric straps, cable tie straps, zip-ties, brackets, fasteners, hinges, other fasteners such as screws, and other similar elements.

As noted above, the main body portion 22 may be attached to any portion of the yard sign including, but not limited to, the sign portion 14 or the frame 12. Also, although the illumination device embodiments depicted in FIGS. 1 and 1A are attached proximate the top and bottom portions of the yard sign, other illumination device embodiments may be attached proximate the lateral edges of the yard sign or perhaps may be attached through apertures disposed within the exterior perimeter of the sign portion of the yard sign.

Referring again to FIGS. 2-4, in one embodiment, the illuminating device 20 includes a removable cap 32 located at a first end of the main body portion 22. In the depicted embodiment, the removable cap 32 defines threads that allow the cap 32 to screw onto reciprocal threads defined in the main body portion 22. In other embodiments, however, the removable cap 32 may removably couple to the main body portion 22 in various other ways, including, but not limited to a snap-fit arrangement.

The depicted illuminating device 20 includes a rotatable user interface portion 31 located at a second end of the main body portion 22 that is structured to engage a switch 30. In the depicted embodiment, the user interface portion 31 is a cap apparatus that may be rotated by a user to close electrical contacts thereby engaging the switch 30. Although in the depicted embodiment, the switch 30 is mechanically engaged by the user interface portion 31, which is generally integral to the main body portion 22, in various other embodiments, the switch 30 may be engaged remotely or wirelessly by a command signal.

In the depicted embodiment, the shape and material of the rotatable cap 32 and the user interface portion 31 are similar to the shape and material of the main body portion 22, namely, they are generally cylindrical and constructed of a polymer such as ABS. However, in alternate embodiments, the rotatable cap 32 and the user interface portion 31 may be of any shape and constructed of any material or materials that, together with the main body portion, are capable of protecting the internal components of the illuminating device 20 from elements encountered in an outdoor environment.

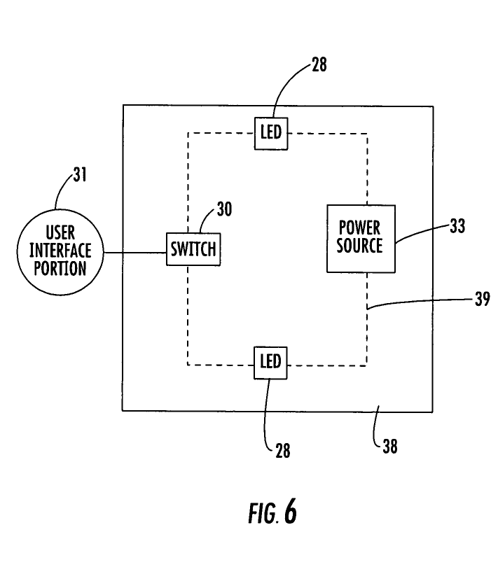

The depicted illumination device 20 includes two positionable arms 24 extending from the main body portion 22. The positionable arms 24 define a first end 23 that is generally fixed adjacent the main body portion 22 and a second end 25 that is generally movable away from the main body portion 22 as shown in FIG. 5. Light heads 26 structured to support LED assemblies 28 are disposed adjacent the second ends 25 of the positionable arms 24. In the depicted embodiment, the positionable arms 24 are constructed generally of steel that is powder coated to improve corrosion resistance. In alternate embodiments, the positionable arms 24 may be constructed of a flexible conduit housing a heavy gauge wire that may be positioned by a user to hold a desired shape. In still other embodiments, the positionable arms 24 may be comprised of a variety of materials including metals, polymers, composites, rubbers, wood, and combinations thereof.

The depicted arms 24 are structured in a compact arrangement such that the LED assemblies 28 are positionable to illuminate a yard sign and yet do not significantly obscure a viewer's ability to read the sign. This is advantageously accomplished through the use of a small and efficient LED light source. In the depicted embodiment, each LED assembly 28 comprises a pair of high brightness white LEDs. However, LED assemblies 28 structured in accordance with various embodiments of the present invention may comprise any other type of LEDs including, but not limited to, blue LEDs, red LEDs, orange LEDs, amber LEDs, yellow LEDs, green LEDs, and/or bi- or tri-color LEDs. LED assemblies 28 structured in accordance with various embodiments of the present invention need not be limited to having two LEDs. Rather, such LED assemblies 28 may have a single LED or an array of LEDs comprising greater than two LEDs.

In one embodiment, the light heads 26 are sized large enough to support the LED assembly while remaining small enough to prevent undue obstruction of the sign. For example, in one embodiment, a light head supporting two LEDs may define a light head diameter between 0.75 and 1.25 inches, preferably approximately 1 inch. In another embodiment, a light head supporting one LED may define a light head diameter between 0.25 and 0.75 inches, preferably approximately 0.5 inches. In still another embodiment, a light head supporting three LEDs may define a light head diameter between 1.25 and 1.75 inches, preferably 1.5 inches. Larger light diameters may be used to correspond with light heads having a greater number of LEDs. Additionally, as LED technology is improved and LEDs get smaller and more efficient, the diameter of the light heads set forth above may be reduced accordingly as will be apparent to one of ordinary skill in the art.

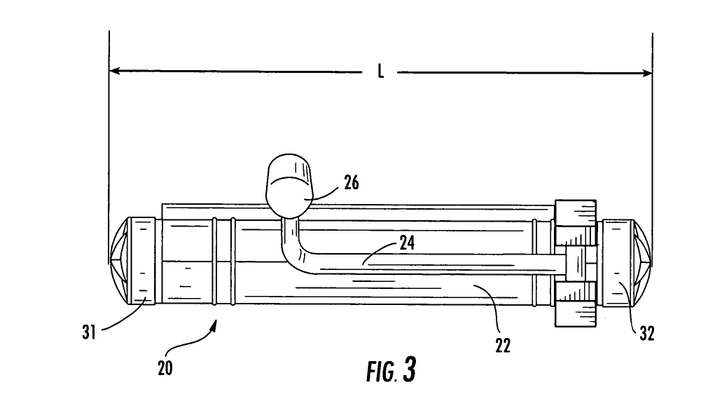

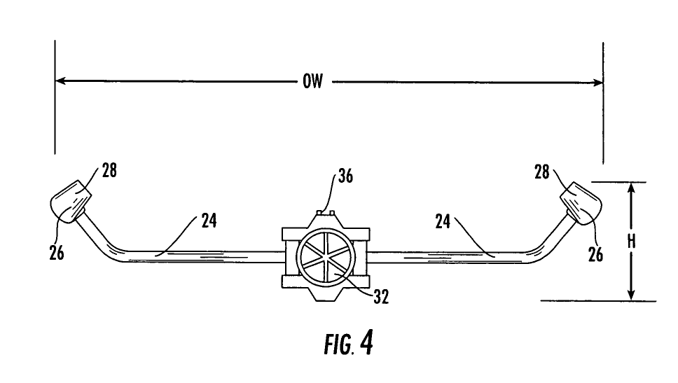

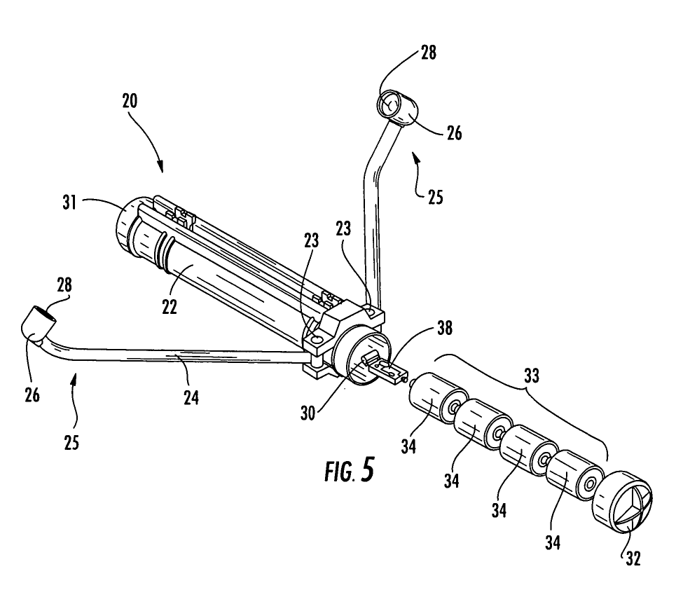

The relatively compact design principles noted above are not necessary limited to the design of the light heads. Illumination devices structured in accordance with various embodiments of the present invention may define a length L as shown in FIG. 3. In various embodiments, the length L of the illumination device is less than 15 inches, preferably less than 13 inches, and more preferably approximately 12 inches. Various illumination device embodiments may also define a height H between the bottom of the device and the top of the light head(s) as shown in FIG. 4. For example, the height H of the illumination device may range between 1.5 and 6 inches, preferably between 2 and 4 inches, more preferably approximately 2.6 inches.

FIG. 5 shows a partially exploded view of an illuminating device 20 structured in accordance with one embodiment of the present invention. As noted above, in the depicted embodiment, the cap 32 is rotatably removable from the main body portion 22. The main body portion 22 is configured to accommodate a power source 33 and a circuit board 38 that is structured in electrical communication with the power source 33 and the LED assemblies 28.

In the depicted embodiment, the power source 33 is a direct current power source provided in the form of one or more batteries 34. The batteries 34 of the depicted embodiment include four standard D cell alkaline batteries that are provided to power the depicted illumination device for approximately thirty days of operation (four hours per day). More or fewer batteries and batteries of differing sizes may be used depending upon size and power specifications of a given application as will be apparent to one of ordinary skill in the art. Further, multiple other power sources may be used including direct current, alternating current, or combinations of the two, and such differing power sources may provide any duration of operation that is suitable for a particular application. As will be apparent to one of ordinary skill in the art, direct current power sources may include, but are not limited to, battery power sources and solar cell power sources such as photovoltaic power sources. Alternating current power sources may include a power cord that is electrically coupled to a home power outlet.

The depicted illumination device is structured such that the batteries 34 may be inserted into the main body portion 22 of the illuminating device 20 by removing the removable cap 32 and inserting the batteries serially as shown. Illumination devices structured in accordance with various embodiments of the present invention are preferably designed such that insertion of the batteries 34, even in an incorrect orientation, will not damage the circuit board 38. In the depicted embodiment, the switch 30, the circuit board 38, and the power source 33 electrically communicate through wired connections, however in various other embodiments the electrical communication may be accomplished in other ways, such as, for example, through direct or wireless communications.

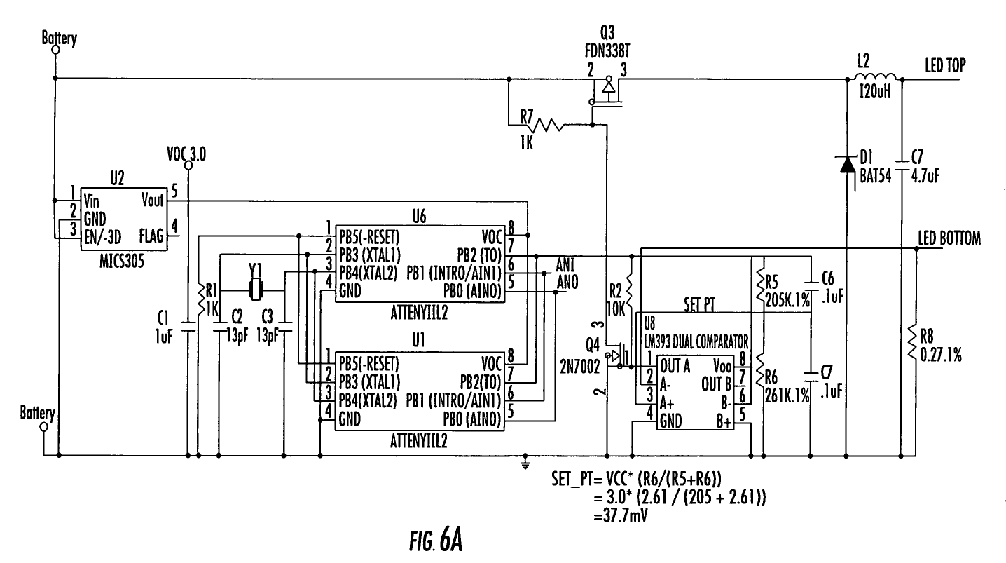

FIG. 6 is a schematic illustration of various electronic components used to drive an illuminating device structured in accordance with one embodiment of the present invention. The depicted illumination device 20 includes a circuit board 38 that is adapted to support and electrically connect the power source 33, the switch 30, and the one or more LED assemblies 28. In the depicted embodiment, the circuit board 38 includes a control circuit 39 that is adapted to engage the LED assemblies 28 at timed intervals in response to activation or closure of the switch 30. As noted above, the depicted switch 30 is closed when a user rotates the user interface portion 31 from an “OFF” position to an “ON” position. Indicia may be provided on the main body portion and/or user interface portion for indicating to a user the relative location of the ON and OFF positions. In the depicted embodiment, the user interface portion 31 engages the switch 30 to close at an ON position that is positioned approximately 30 degrees from the OFF position. In another embodiment, the user interface portion 31 may be structured to announce that the ON position has been reached through an audible click.

In one embodiment, the control circuit 39 includes logic for engaging the LED assemblies 28 on a timed interval or illumination cycle. In various embodiments, the control circuit 39 may include a processor, CPU, chip, or other similar logic employing element (not shown). In one embodiment, the illumination cycle comprises four hours of illumination and twenty hours of non-illumination. Other illumination and non-illumination intervals may be used. The illumination cycle may repeat continuously as long as sufficient power is supplied by the power source 33 and unless deactivated by a user.

The control circuit 37 may be activated in a variety of ways other than the depicted user engaged switch 30. For example, in various embodiments, the control circuit may be engaged or disengaged (i.e., deactivated) using rocker switches, push button switches, remote wireless switches, and the like. In still other embodiments, engagement of the LED assemblies may be tied to the presence or absence of ambient light. For example, in one embodiment, an illumination device may include a photo sensor (not shown) that is adapted to provide a lit/unlit status signal in response to a sensed level of ambient light. If ambient light below a selected level is sensed, an unlit status signal may be sent to the control circuit thereby engaging the LED assemblies to operate. If the sensed ambient light is above the selected level, then a lit status signal may be sent to the control circuit, which thereby controls the LED assemblies to remain off.

FIG. 6A provides a detailed circuit diagram of an electrical circuit board used in an illumination device structured in accordance with one embodiment of the present invention. Table 1 corresponds to FIG. 6A and provides a list of various electrical components that may be used to manufacture an electrical circuit board structured in accordance with one embodiment of the present invention.

TABLE 1

| Part Type | Callout | Footprint | Description |
|---|---|---|---|
| .1uF | C6 C7 | 603 | CAP CER .1UF 16V Y5V 0603 |
| 0.27, 1% | R8 | 603 | RESISTOR .27 OHM 1/10W 1% 0603 |
| 1K | R1 R7 | 603 | RES 1.0K OHM 1/10W 5% 0603 SMD |
| 1uF | C1 | 603 | CAP 1UF 10V CER Y5V SMD 0603 |
| 2.61K, 1% | R6 | 603 | RES 2.61K OHM 1/10W 1% 0603 SMD |
| 2N7002 | Q4 | SOT-23B | IC TRANS N-CH 60V 7.5OKM SOT-23 |
| 4.7uF | C4 | 1206 | CAP CER 4.7UF 10V Y5V 1206 |
| 10K | R2 | 603 | RES 10K OHM 1/10W 5% 0603 SMD |
| 12pF | C2 C3 | 603 | CAP CER 12PF 50V C0G 5% 0603 |
| 32.768 KHz | Y1 | XTAL-CFS206 | CRYSTAL 32.768 KHZ CYL 12.5PF |
| 205K, 1% | RS | 603 | RES 205K OHM 1/10W 1% 0603 SMD |
| 220 uH | L2 | BOURNES-SDR0604 | Inductor Series:SDR0604; Inductance: 220 uH |
| ATTINY11L-2 | U6 | D1P8 | IC AVR MCU 1K 2 MHZ LV IND 8-DIP |
| ATTINY11L-2 | U1 | SOIC8 | IC AVR MCU 8-BIT FLSH LOW V SO-8 |
| BAT54 | D1 | SOT-23B | DIODE SCHOTTKY 30V 200MA SOT-23 |
| FDN338P | Q3 | SOT-23B | P-Channel Logic Level Enhancement Mode |
| | | | Field Effect Transistor |
| LM393 DUAL | U8 | SOIC8 | IC DUAL DIFF COMP 8-SOIC |
| COMPARATOR | | | |
| MIC5205 | U2 | SOT23-5 | IC REG LDO 150MA 3.0V 1% SOT23-5 |
| PCB | N/A | N/A | Printed Circuit Board |

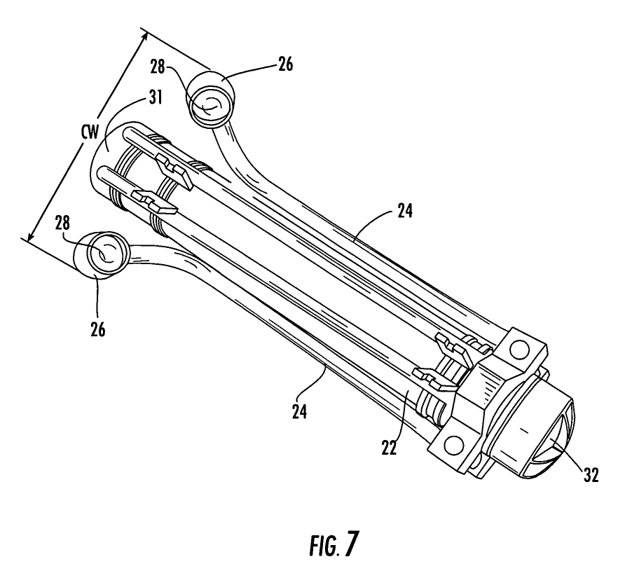

FIG. 7 depicts an illumination device having positionable arms 24 disposed in a closed or retracted position in accordance with one embodiment of the present invention. In such a position, the arms 24 may be aligned along the length of the main body portion 22. The depicted illumination device defines a collapsed width CW between the arms 24 disposed in the collapsed position as shown. In various embodiments, the illumination device may be structured to define a collapsed width CW that is 6 inches or less. The depicted illumination device embodiment defines a collapsed width CW of approximately 4.37 inches. As noted above, the arms 24 are positionable by a user into an operating position as illustrated in FIGS. 2-4. Referring specifically to FIG. 4, the illumination device defines an operating width OW representing the span of the arms 24 in the operating position as shown. In various embodiments, the illumination device may be structured to define an operating width OW that is between 15 and 20 inches, preferably approximately 19.5 inches. In various embodiments, the arms 24 are structured to snap or lock into the desired operating position using mechanical locks, hinges, and the like such that they do not collapse into a retracted position during use. In other embodiments, flexible gooseneck type arms may be used that readily accept and hold a variety of positions.

Many modifications and other embodiments of the invention set forth herein will come to mind to one skilled in the art to which this invention pertains having the benefit of the teachings presented in the foregoing descriptions and the associated drawings. Therefore, it is to be understood that the invention is not to be limited to the specific embodiments disclosed and that modifications and other embodiments are intended to be included within the scope of the appended claims. Although specific terms are employed herein, they are used in a generic and descriptive sense only and not for purposes of limitation.

That which is claimed:

1. An illuminating device adapted for use in illuminating a yard sign that is structured to be removably inserted into the ground, the illuminating device comprising:
a main body portion structured for attachment to the yard sign;
a power source;
at least one arm extending from the main body portion; and
a light head disposed proximate an end of the at least one arm, the light head comprising at least one light emitting diode (LED) that is structured for illuminating the yard sign.

2. The illuminating device of claim 1, wherein the yard sign comprises a frame and a sign portion, and wherein the main body portion comprises at least one fastener that is structured for coupling the main body portion to the frame of the yard sign.

3. The illuminating device of claim 1, wherein the yard sign comprises a frame and a sign portion, and wherein the main body portion comprises at least one fastener that is structured for coupling the main body portion to the sign portion of the yard sign.

4. The illuminating device of claim 1, wherein the power source comprises one or more batteries, and wherein the illuminating device defines a pre-battery weight between 200 and 400 grams.

5. The illuminating device of claim 1, wherein the at least one LED is selected from a group comprising a high brightness white LED, a blue LED, a red LED, an orange LED, an amber LED, a yellow LED, a green LED, a bi-color LED, and a tri-color LED.

6. The illuminating device of claim 1, wherein the power source is selected from a group comprising a direct current power source and an alternating current power source.

7. The illuminating device of claim 1, wherein the light head defines a diameter between 0.25 and 1.75 inches to reduce the likelihood that the light head will obscure the yard sign from view.

8. The illuminating device of claim 1, wherein the main body portion defines a length that is less than approximately 15 inches.

9. The illuminating device of claim 1, further comprising a control circuit disposed in electrical communication with the power source and the at least one LED, wherein the control circuit is configured to engage the at least one LED to illuminate for a first period and remain dark for a second period.

10. The illuminating device of claim 9, wherein the control circuit is adapted to allow a user to select a duration for the first period and a duration for the second period.

11. The illuminating device of claim 1, wherein the at least one arm may be extended from a collapsed position to an operating position.

12. An illuminating device for use in illuminating a yard sign, the illuminating device comprising:
a main body portion structured to attach to the yard sign;
at least one light emitting diode (LED) that is structured for illuminating the yard sign;
a power source;
a photosensor adapted to sense an ambient light level; and
a control circuit disposed in electrical communication with the power source, the photosensor, and the at least one LED, wherein the control circuit is structured to engage the at least one LED to illuminate in response to the photosensor sensing the ambient light level.

13. The illuminating device of claim 12, wherein the power source comprises one or more batteries, and wherein the illuminating device defines a pre-battery weight between 200 and 400 grams.

14. The illuminating device of claim 12, wherein the at least one LED is selected from a group comprising a high brightness white LED, a blue LED, a red LED, an orange LED, an amber LED, a yellow LED, a green LED, a bi-color LED, and a tri-color LED.

15. The illuminating device of claim 12, wherein the power source is a direct current power source.

16. The illuminating device of claim 15, wherein the direct current power source is a solar array.

17. The illuminating device of claim 12, wherein the main body portion defines a length that is less than approximately 15 inches.

18. The illuminating device of claim 12, further comprising a first arm adapted to support a first LED and a second arm adapted to support a second LED, wherein the first and second arms may be extended from a compact position to an operating position.

19. The illuminating device of claim 18, wherein the yard sign defines opposed first and second surfaces, and wherein the first and second LEDs are positioned to illuminate the first and second surfaces of the yard sign, respectively, when the first and second arms are extended into the operating position.

20. A display system comprising:
a yard sign comprising a sign portion and a frame portion, wherein at least part of the frame portion is structured for removable insertion into a ground surface;
an illuminating device, comprising:
a main body portion structured for removable attachment to the yard sign,
a control circuit enclosed within the main body portion,
a power source disposed in electrical communication with the control circuit, and
a light head comprising at least one light emitting diode (LED) that is coupled to the main body portion and disposed in electrical communication with the control circuit,
wherein the control circuit is configured to engage the at least one LED to illuminate at least a part of the sign portion of the yard sign for a first period and remain dark for a second period.

21. The display system of claim 20, wherein the frame portion of the yard sign defines a stake for insertion into the ground surface and wherein the illuminating device defines an operational weight between 800 and 1000 grams to enhance the likelihood that the yard sign will remain in a stable upright position when the stake is inserted into the ground surface.

22. The display system of claim 20, wherein the at least one LED is selected from a group comprising a high brightness white LED, a blue LED, a red LED, an orange LED, an amber LED, a yellow LED, a green LED, a bi-color LED, and a tri-color LED.

23. The display system of claim 20, wherein the power source is a direct current power source.

24. The display system of claim 20, wherein the direct current power source is a solar array.

25. The display system of claim 20, wherein the main body portion defines a length that is less than approximately 15 inches.

26. The display system of claim 20, further comprising a first arm adapted to support a first LED and a second arm adapted to support a second LED, wherein the first and second arms may be extended from a compact position to an operating position.

27. The display system of claim 26, wherein the sign portion of the yard sign defines opposed first and second surfaces, and wherein the first and second LEDs are positioned to illuminate the first and second surfaces of the sign portion of the yard sign, respectively, when the first and second arms are extended into the operating position.

28. The display system of claim 20, wherein the control circuit is adapted to allow a user to select a duration for the first period and a duration for the second period.

29. The display system of claim 20, wherein the control circuit is adapted to cycle between the first period and the second period substantially continuously until the power source becomes substantially exhausted.

30. The display system of claim 20, wherein the light head defines a diameter between 0.25 and 1.75 inches to reduce the likelihood that the light head will obscure the sign portion of the yard sign from view.

31. An illuminating device for use in illuminating a yard sign, the illuminating device comprising:
a main body portion structured for removable attachment to the yard sign;
at least one light emitting diode (LED) that is structured for illuminating at least a part of the yard sign;
a power source; and
a control circuit disposed in electrical communication with the power source and the at least one LED, wherein the control circuit is configured to engage the at least one LED to illuminate the at least a part of the yard sign for a first period and remain dark for a second period.
